(19) United States
(12) Patent Application Publication
(10) Pub. No.: US 2021/0339574 A1
(43) Pub. Date: Nov. 4, 2021

(54) TIRE TREAD WEAR INDICATORS AND TIRES INCLUDING SAME

(71) Applicant: Jinwoo Jang, Glen Ellyn, IL (US)

(72) Inventor: Jinwoo Jang, Glen Ellyn, IL (US)

(21) Appl. No.: 17/246,723

(22) Filed: May 3, 2021

Related U.S. Application Data
(60) Provisional application No. 63/019,165, filed on May 1, 2020.

(51) Int. Cl. B60C 11/24; B60C 11/00

(52) U.S. Cl. CPC B60C 11/24; B60C 11/0041

(57) ABSTRACT

The present disclosure provides tire tread wear indicators, tires incorporating same, and methods of making and using same.

### PRIORITY CLAIM

This application claims priority to U.S. Provisional Patent Application Ser. No. 63/019,165, filed May 1, 2020, the entire contents of which are incorporated herein by reference and relied on.

### FIELD

The present disclosure provides tire tread wear indicators, tires including same, and methods of making and using same.

### BACKGROUND

Currently, there are many methods to check the tread wear of the tire such as using a coin, tire tread depth gauge and also going to a mechanic to obtain a report of tread wear. These methods are either not accurate, inconvenient, or require expensive equipment or high costs.

A need persists for tires that provide convenient and accurate tread wear pattern information.

### SUMMARY

The present disclosure provides tire tread wear indicators, tires including same, and methods of making and using same.

In some embodiments, the present disclosure provides a tire tread wear indicator comprising: a first indicator layer including a first indicator color; a second indicator layer including a second indicator color and disposed adjacent to the first indicator layer; and a third indicator layer including a third indicator color and disposed adjacent to the second indicator layer opposite the first indicator layer, wherein the first indicator color is substantially different than the second indicator color, and wherein the second indicator color is substantially different than the third indicator color.

In other embodiments, the present disclosure provides a tire including at least one tire tread wear indicator as disclosed herein.

In still other embodiments, the present disclosure provides a method of identifying an adjustment requirement associated with a vehicle, the method comprising: providing a tire comprising a plurality of tire tread wear indicators as disclosed herein; determining, after a period of time wherein the tire is used on a vehicle, a level of wear associated with each of the plurality of tire tread wear indicators; appreciating a wear pattern associated with the determined levels of wear associated with each of the plurality of tire tread wear indicators; and identifying an adjustment requirement associated with the vehicle based on the appreciated wear pattern.

In other embodiments, the present disclosure provides a tire making mold comprising: a plurality of wells corresponding to a plurality of blocks and/or ribs of a molded tire; a plurality of first protrusions surrounding the plurality of wells and corresponding to a plurality of grooves of the molded tire; and a plurality of protrusions disposed within at least some of the plurality of wells and corresponding to a plurality of molded holes in the blocks and/or ribs of the molded tire, wherein each of the plurality of protrusions is configured to receive a tire tread wear indicator comprising a plurality of indicator layers.

One object is to provide a tire with a colored tread wear indicator for anyone to easily check the tread wear of the tire. Currently, there are many methods to check the tread wear of the tire such as using a coin, tire tread depth gauge and also going to a mechanics that gives report of the tread wear. Tires also have a wear indicator called tire wear bars embedded inside the groove that shows when the tire is at end of life. But all of these methods are either not accurate or require additional cost.

Another object is to provide a tire with a colored tread wear indicator that allows a visual check by looking at the color of the tread wear indicator to determine the tread wear of the tire.

Another object is to provide a tire with a colored tread wear indicator that allows to find the reason for abnormal tread wear by looking at the overall pattern of the color of the tread wear indicators.

Another object is to provide a tire with a colored tread wear indicator that can be inserted manually by the user.

Other objects and advantages of the various embodiments of the present invention will become obvious to the reader and it is intended that these objects and advantages are within the scope of the present invention.

These and other embodiments are described in greater detail below with respect to the accompanying figures.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a perspective view of a tire tread wear indicator consistent with one embodiment of the present disclosure.

FIG. 2 shows a perspective view of a tire tread wear indicator consistent with another embodiment of the present disclosure.

FIG. 3 shows a perspective view of a tire tread wear indicator consistent with another embodiment of the present disclosure.

FIG. 4 shows a perspective view of a tire tread wear indicator consistent with another embodiment of the present disclosure.

FIG. 5A shows a perspective view of a tire tread wear indicator consistent with another embodiment of the present disclosure.

FIG. 5B shows a perspective view of a tire tread wear indicator consistent with another embodiment of the present disclosure.

FIG. 6A shows a perspective schematic view of a pair of tire tread wear indicators generally consistent with the tire tread wear indicator of FIG. 4 after a period of use.

FIG. 6B shows a perspective schematic view of a pair of tire tread wear indicators generally consistent with the tire tread wear indicator of FIG. 5 after a period of use.

FIG. 7 shows a cross-sectional view of a tire equipped with a plurality of tire tread wear indicators consistent with one embodiment of the present disclosure.

FIG. 8 shows a perspective view of a portion of the tire of FIG. 7.

FIG. 9 shows a cross-sectional view of a tire equipped with a plurality of tire tread wear indicators consistent with one embodiment of the present disclosure.

FIG. 10 shows a perspective view of a portion of the tire of FIG. 9.

FIG. 11 shows a side plan view of a wheel including a tire equipped with a plurality of tire tread wear indicators consistent with one embodiment of the present disclosure.

FIG. 12 shows a front plan view of the wheel of FIG. 11.

FIG. 13 shows a perspective view of a portion of a tread section of a tire including a plurality of bore holes each configured to accept a tire tread wear indicator consistent with one embodiment of the present disclosure.

FIG. 14 shows a perspective view of a portion of a tire mold configured to mold a plurality of bore holes in a tread section of a tire.

FIG. 15A shows a sagittal cross-sectional view of a portion of a tire including a tire tread wear indicator consistent with one embodiment of the present disclosure.

FIG. 15B shows a top plan view of the tire of FIG. 15A.

FIG. 16A shows a sagittal cross-sectional view of a portion of a tire including a tire tread wear indicator consistent with one embodiment of the present disclosure.

FIG. 16B shows a top plan view of the tire of FIG. 16A.

FIG. 17A shows a sagittal cross-sectional view of a portion of a tire including a tire tread wear indicator consistent with one embodiment of the present disclosure.

FIG. 17B shows a top plan view of the tire of FIG. 17A.

FIG. 18 shows a front plan view of a tire equipped with a plurality of tire tread wear indicators consistent with one embodiment of the present disclosure indicating an alignment issue.

FIG. 19 shows a front plan view of a tire equipped with a plurality of tire tread wear indicators consistent with one embodiment of the present disclosure indicating a balance issue.

FIG. 20 shows a front plan view of a tire equipped with a plurality of tire tread wear indicators consistent with one embodiment of the present disclosure indicating an overinflation issue.

FIG. 21 shows a front plan view of a tire equipped with a plurality of tire tread wear indicators consistent with one embodiment of the present disclosure indicating an underinflation issue.

FIG. 22 shows a flowchart representing a method of doing business associated with tire tread wear indicators consistent with one embodiment of the present disclosure.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

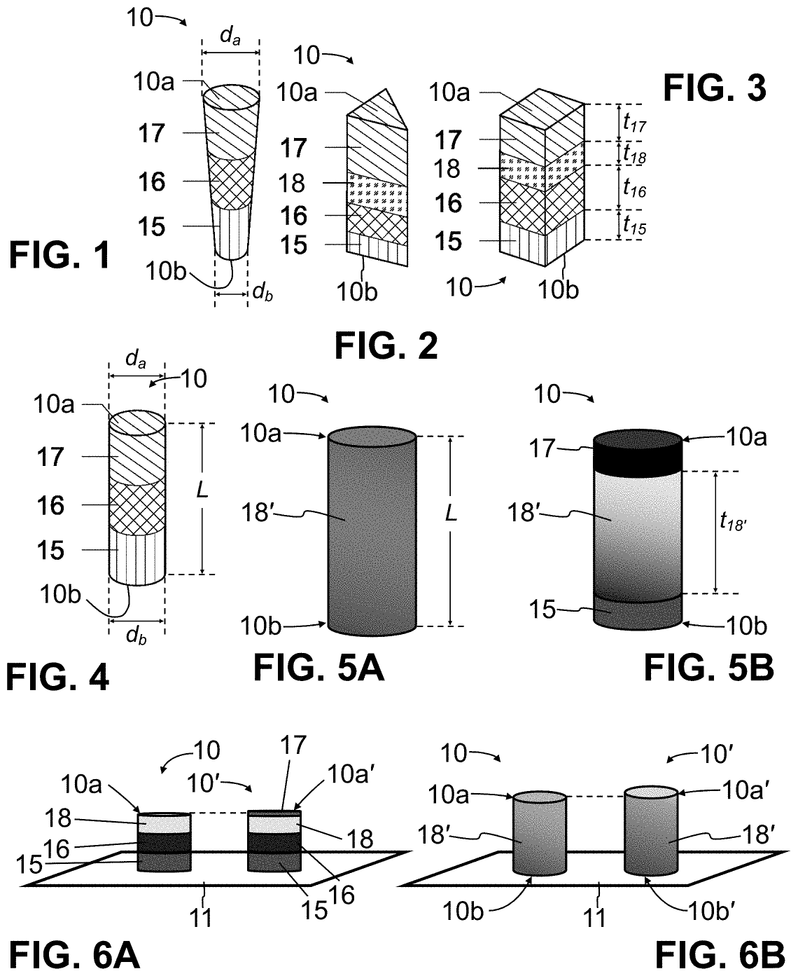

Referring generally to FIGS. 1-22, the present disclosure provides tire tread wear indicators, tires including same, and methods of making and using same.

In general, tire tread wear indicators consistent with the present disclosure include a plurality of layers configured to visually indicate a level of wear of tire tread proximal to the tire tread wear indicator.

1. Tire Tread Wear Indicators

In some embodiments, the present disclosure provides tire tread wear indicators 10 configured to visually indicate a level of wear of tire tread proximal to the tire tread wear indicators 10. Generally, the tire tread wear indicators 10 include a visual indicator, such as colors or visual patterns, that enable an observer to quickly and conveniently determine a level of tread wear proximal to the tire tread wear indicator 10.

Referring now specifically to FIGS. 1-4, tire tread wear indicators 10 consistent with the present disclosure may include a plurality of layers 15-18 each having a distinct visual indicator (e.g., a color indicator and/or a visual pattern indicator) that enables the observer to quickly identify the outermost layer of the tire tread wear indicator 10 exposed in an associated tire 11.

In some embodiments, such as those specifically illustrated in FIGS. 1 and 4, the tire tread wear indicator 10 includes a first indicator layer 15 disposed at an inner end 10b of the tire tread wear indicator 10, a third indicator layer 17 disposed at an outer end 10a of the tire tread wear indicator 10, and optionally a second indicator layer 16 disposed between the first indicator layer 15 and the third indicator layer 17. Each of the first indicator layer 15, the third indicator layer 17, and the second indicator layer 16 (when present) includes a different visual indicator, such as a color, a visual pattern, or both. For example and without limitation, in one specific embodiment a tire tread wear indicator 10 may include a first indicator layer 15 that has a red color, a third indicator layer 17 that has a green color, and a second indicator layer 16 that includes a yellow color. Visual inspection of a tire including a plurality of such tire tread wear indicators 10 enables the observer to quickly determine whether the tire is wearing evenly over time, and/or approximately how much tread remains on the tires by appreciating the observable color(s) of the tire tread wear indicators 10.

In some embodiments, the third indicator layer 17 includes a black color or a color similar to the color of the tire tread. In such embodiments, the tire tread wear indicators 10 are barely perceptible by the observer upon initial use of a tire including such tire tread wear indicators 10. This can ensure that any variations in observable colors and/or patterns after an initial break-in period of use reflect a sufficient duration of tire use and therefore reliable observable data associated with the tire tread wear indicators 10.

In some embodiments, such as those specifically illustrated in FIGS. 2-3, a tire tread wear indicator 10 includes a first indicator layer 15 disposed at an inner end 10b of the tire tread wear indicator 10, a third indicator layer 17 disposed at an outer end 10a of the tire tread wear indicator 10, a second indicator layer 16 disposed between the first indicator layer 15 and the third indicator layer 17, and a fourth indicator layer 18 disposed between the second indicator layer 16 and the third indicator layer 17. Each of the first indicator layer 15, the third indicator layer 17, the second indicator layer 16, and the fourth indicator layer 18 includes a different visual indicator, such as a color, a visual pattern, or both. For example and without limitation, in one specific embodiment a tire tread wear indicator 10 may include a first indicator layer 15 that has a white color, a third indicator layer 17 that has a black color, a second indicator layer 16 that includes an orange color, and a fourth indicator layer 18 that includes a brown color. Visual inspection of a tire including a plurality of such tire tread wear indicators 10 enables the observer to quickly determine whether the tire is wearing evenly over time, and/or approximately how much tread remains on the tires by appreciating the observable color(s) of the tire tread wear indicators 10.

In some embodiments, the tire tread wear indicator 10 includes more than four indicator layers 15-18, such as 5 indicator layers, 6 indicator layers, 7 indicator layers, 8 indicator layers, 9 indicator layers, 10 indicator layers, or more than 10 indicator layers.

Each indicator layer 15-18 includes a visual indicator feature that is unique to that indicator layer such that an observer can quickly and conveniently determine which indicator layer 15-18 is exposed, and therefore a level of tread wear proximal to each tire tread wear indicator 10. In some embodiments, the visual indicator feature comprises, consists essentially of, or consists of a color. Examples of suitable colors include, but are not limited to, white, black, brown, gray, red, orange, yellow, green, blue, indigo, violet, and pink. In some embodiments, the visual indicator feature comprises, consists essentially of, or consists of a visual pattern. Examples of suitable visual patterns include stripes, symbols, letters, numbers, dots, cross-hatching, and checkered patterns. In some embodiments, the visual indicator feature includes both a color indicator feature and a visual pattern, such as any combination of one or more colors listed above and one or more visual patterns listed above.

Referring now specifically to FIG. 5A, in some embodiments, the tire tread wear indicator 10 includes no discrete indicator layers 15-18, but instead comprises, consists essentially of, or consists of a color gradient 18′ from the outermost end 10a to the bottom end 10b.

In some embodiments, such as those generally consistent with the embodiment specifically illustrated in FIG. 5B, a tire tread wear indicator 10 consistent with the present disclosure includes one or more discrete indicator layers 15-18 and a color gradient indicator layer 18′. The color gradient indicator layer 18′ may have a thickness t_{18′} that is greater than, about equal to, or less than the thickness t of any other indicator layer 15-18 present in the tire tread wear indicator 10. For example and without limitation, the tire tread wear indicator 10 may include an outermost layer 17 including a discrete indicator color (e.g., black) that serves as a break-in layer. The tire tread wear indicator 10 may additionally include an innermost indicator layer 15 including a discrete indicator color (e.g., red) that serves as a warning layer (e.g., to indicate that the tire has less tread than advisable for safe use). The tire tread wear indicator 10 may additionally include a gradient indicator layer 18′ disposed between the outermost layer 17 and the innermost layer 15.

Tire wear indicators 10 including a color gradient indicator layer 18′ offer some advantages over embodiments including discrete indicator layers 15-18. For example and without limitation, a color gradient 18′ enables manufacturing of tire tread wear indicators 10 with reduced layer thickness t tolerances compared to tire wear indicators 10 including discrete indicator layers 15-18. In addition, methods of identifying an adjustment requirement associated with a vehicle disclosed herein may be performed with greater precision and reduced error using tire tread wear indicators 10 that feature a color gradient 18′ compared to similar methods performed using tire tread wear indicators 10 featuring discrete indicator layers 15-18. FIGS. 6A-6B illustrate one example of such reduced error. In FIG. 6A, two tire tread indicators 10-10′ featuring discrete indicator layers 15-18 that wear unevenly may provide inaccurate or misleading information about needed adjustments. In this example, one tire tread wear indicator 10 has a yellow layer 18 exposed on its outer face 10a, while the other tire tread wear indicator 10′ has a green layer 17 exposed on its outer face 10a′ despite both tire tread wear indicators 10-10′ being worn a nearly identical amount (dashed line). The variation may be due to manufacturing variations (e.g., blue layer 16 may be slightly thicker tin one tire tread indicator 10′ than in the other tire tread wear indicator 10, or one tire tread wear indicator 10′ may be inserted slightly deeper into the tire 11 than the other tire tread wear indicator 10). In contrast, tire tread wear indicators 10-10′ featuring a color gradient 18′ (FIG. 6B) reduce or even eliminate error in assessing localized tread wear.

In this comparative example, tire tread wear indicators 10-10′ have worn the same extent as the tire tread wear indicators 10-10′ in FIG. 6A, respectively. However, the presence of the color gradient 18′ results in the exposed faces 10a-10a′ of the tire tread wear indicators 10-10′ showing very similar colors.

The tire tread wear indicators 10 have a length L less than the tread thickness t₁₂ of the tire proximal to the tire tread wear indicator 10. In some embodiments, the length L is as long or longer than the depth t₁₄ of tread wells 14 proximal to the tire tread wear indicator 10. In some embodiments, the length L of the tire tread wear indicator 10 is at least 1/32 inch, at least 1/16 inch, at least 3/32 inch, or at least ⅛ inch longer than the depth t₁₄ of the tread well 14 proximal to the tire tread wear indicator 10.

Each indicator layer 15-18 has a predetermined thickness t. In some embodiments, the predetermined thickness t of each indicator layer 15-18 is independently selected from the group consisting of: ⅓ inch, 1/16 inch, 3/32 inch, ⅛ inch, 5/32 inch, 3/16 inch, 7/32 inch, ¼ inch, 9/32 inch, 5/16 inch, 11/32 inch, ⅜ inch, 13/32 inch, 7/16 inch, 15/32 inch, ½ inch, 17/32 inch, 9/16 inch, 19/32 inch, ⅝ inch, 21/32 inch, 11/16 inch, 23/32 inch, ¾ inch, 25/32 inch, 13/16 inch, 27/32 inch, ⅞ inch, 29/32 inch, 15/16 inch, 31/32 inch, or 1 inch. In some embodiments, the predetermined thickness t of each indicator layer 15-18 is independently selected from the group consisting of: 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or 25 mm. In some embodiments, the first indicator layer 15 has a thickness t₁₅ of about 1/16 inch (about 1.6 mm), and when exposed may indicate to the observer that the level of tread proximal to that tire tread wear indicator 10 is below safe (e.g., legal) limits. In some embodiments, the third indicator layer 17 has a thickness t₁₇ of about 3/16 inch (about 4.8 mm), and when exposed may indicate to the observer that the tire has not yet been worn sufficiently to provide useful wear pattern data.

In some embodiments, each indicator layer 15-18 has the same thickness t, or substantially the same thickness t.

In other embodiments, each indicator layer 15-18 has a different thickness t. For example and without limitation, the first indicator layer 15 may have a thickness t₁₅ of about 1/16 inch, the third indicator layer 17 may have a thickness t₁₇ of about 3/16 inch, the second indicator layer 16 (when present) may have a thickness t₁₆ of about ⅛ inch, and the fourth indicator layer 18 (when present) may have a thickness t₁₈ of about ⅜ inch.

In some embodiments, the first indicator layer 15 has a thickness t₁₅ that is about 1/16 inch longer than the difference between the total length L of the tire tread wear indicator 10 and the depth t₁₄ of the tread well 14 proximal to the tire tread wear indicator 10. In such embodiments, the first indicator layer 15 becomes exposed when the remaining tire tread 14 of the tire 11 is reduced to about 1/16 inch (e.g., the minimum tire tread level permitted for legal use in the United States).

The tire tread wear indicators 10 consistent with the present disclosure may have any suitable shape to be securely disposed in a hole 100 or tread well 14 of a tire 11. For example and without limitation, the tire tread wear indicators 10 may have a generally cylindrical shape, a generally triangular prismatic shape, a generally frustoconical shape, a generally rectangular prismatic shape, a barbed cylinder shape, a barbed triangular prism shape, a barbed frustoconical shape, or a barbed rectangular prism shape. In this broad sense, the tire tread wear indicators 10 may be configured to be inserted into a tire 11 similar to how a “plug” may be forced into a hole and/or may be inserted into a tire 11 using adhesive.

In some embodiments, such as those generally consistent with the example specifically illustrated in FIG. 1, the tire tread wear indicator 10 has a tapered shape. In some embodiments, the tapered shape includes a larger maximum dimension (e.g., a larger diameter dₐ) at the outermost end 10a, and a smaller maximum dimension (e.g., a smaller diameter d_{b}) at the innermost end 10b. In other embodiments, the tapered shape includes a smaller maximum dimension (e.g., a smaller diameter dₐ) at the outermost end 10a, and a larger maximum dimension (e.g., a larger diameter d_{b}) at the innermost end 10b. In still other embodiments, the tapered shape includes a larger maximum dimension near the middle of the tire tread wear indicator 10 than at either the outermost end 10a or the innermost end 10b (not shown).

In some embodiments, the tire tread wear indicator 10 includes barbs and/or ridges (not shown) disposed on or integrated with the side(s) and configured to improve purchase of the tire tread indicator 10 within a bore hole or tread well of a tire.

In some embodiments, such as those consistent with the example specifically illustrated in FIG. 1, the tire tread wear indicator 10 has an overall frustoconical shape. In such embodiments, the diameter dₐ of the tire tread wear indicator 10 at the outermost end 10a is larger than the diameter d_{b} of the tire tread wear indicator 10 at the innermost end 10b.

In some embodiments, such as those consistent with the example specifically illustrated in FIG. 2, the tire tread wear indicator 10 has an overall shape of a triangular prism. In such embodiments, the dimensions of the triangle shape at the outermost end 10a are the same or substantially the same as the dimensions of the triangle shape at the innermost end 10b.

In some embodiments, such as those consistent with the example specifically illustrated in FIG. 3, the tire tread wear indicator 10 has an overall shape of a square prism. In such embodiments, the dimensions of the square shape at the outermost end 10a are the same or substantially the same as the dimensions of the square shape at the innermost end 10b.

In some embodiments, such as those consistent with the example specifically illustrated in FIGS. 4-5B, the tire tread wear indicator 10 has an overall shape of a cylinder. In such embodiments, the diameter dₐ of the tire tread wear indicator 10 at the outermost end 10a is the same or substantially the same as the diameter d_{b} of the tire tread wear indicator 10 at the innermost end 10b.

Tire tread wear indicators 10 consistent with the present disclosure can be formed of any suitable materials, so long as the tire tread wear indicators 10 wear at a rate substantially similar to, or moderately more rapidly than, the wear rate of the tire in which the tire tread wear indicators 10 are embedded. In some embodiments, the tire tread wear indicator 10 has a hardness value of about Shore 55 A, about Shore 60 A, about Shore 65 A, about Shore 70 A, or about Shore 75 A.

In some embodiments, the tire tread wear indicator 10 comprises rubber, such as natural rubber, butadiene rubber, styrene-butadiene rubber, and/or halobutyl rubber. In some embodiments, the tire tread wear indicator 10 further comprises silica and/or sulfur.

In some embodiments, the tire tread wear indicator 10 further comprises an antioxidant. Suitable non-limiting examples of antioxidants include AMINOX stabilizer, BLE 65 stabilizer, a thioester (e.g., NAUGARD DTDTDP thioester), a phenolic antioxidant (e.g., LOWINOX CPL stabilizer), and/or a phosphite stabilizer (e.g., WESTON 398 phosphite).

In some embodiments, the tire tread wear indicator 10 further comprises an antiozonant. Suitable non-limiting examples of an antiozonant include FLEXZONE 3C, FLEXZONE 4L, and FLEXZONE 11 L.

In some embodiments, the tire tread wear indicator 10 further comprises a filler. Non-limiting examples of suitable fillers include calcium carbonate, mica (e.g., ultra-fine mica), and barites (e.g., barium sulfate).

In some embodiments, the tire tread wear indicator 10 further comprises a colorant. Non-limiting examples of suitable colorants include carbon black, molybdenum pigments, pyrazolone orange/yellow, disazo pyrazolone red, and phthalocyanine blue.

In some embodiments, the tire tread wear indicator 10 further comprises a curing agent. Non-limiting examples of suitable curing agents include HEPTEEN Base curing agent, zinc oxide, and activators (e.g., BIK OT surface treated urea activator)

2. Tires Including Tire Tread Wear Indicators

The present disclosure provides tires 11 including at least one tire tread wear indicator 10 as disclosed herein. Tires including tire tread wear indicators 10 have several advantages over tires commercially available.

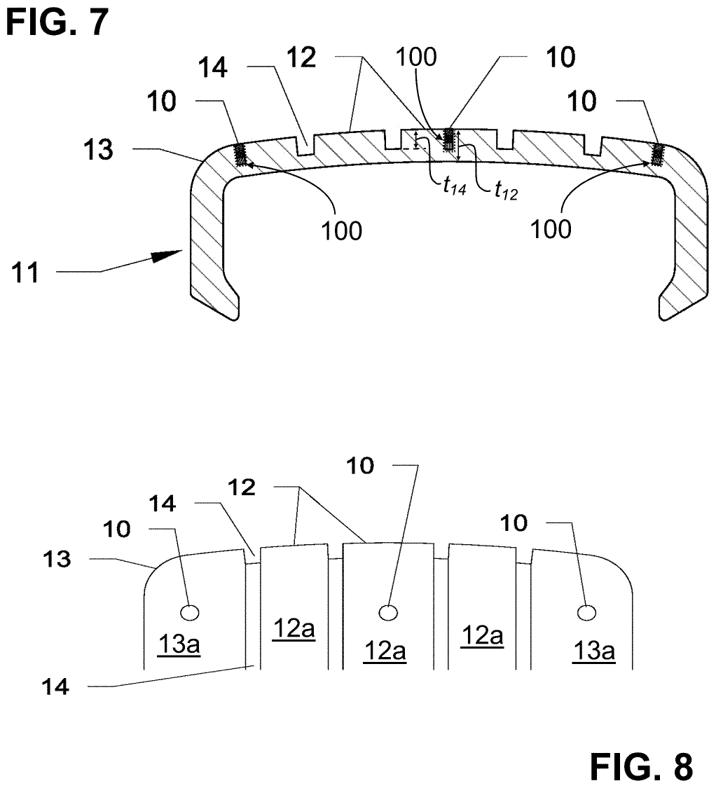

Referring now generally to FIGS. 7-12, one or more tire tread wear indicators 10 are disposed in center tread 12 and/or shoulder tread 13 of the tire 11 to enable an observer to conveniently determine the level of center tread 12 and/or shoulder tread 13 remaining on the tire 11 without using a tread gauge.

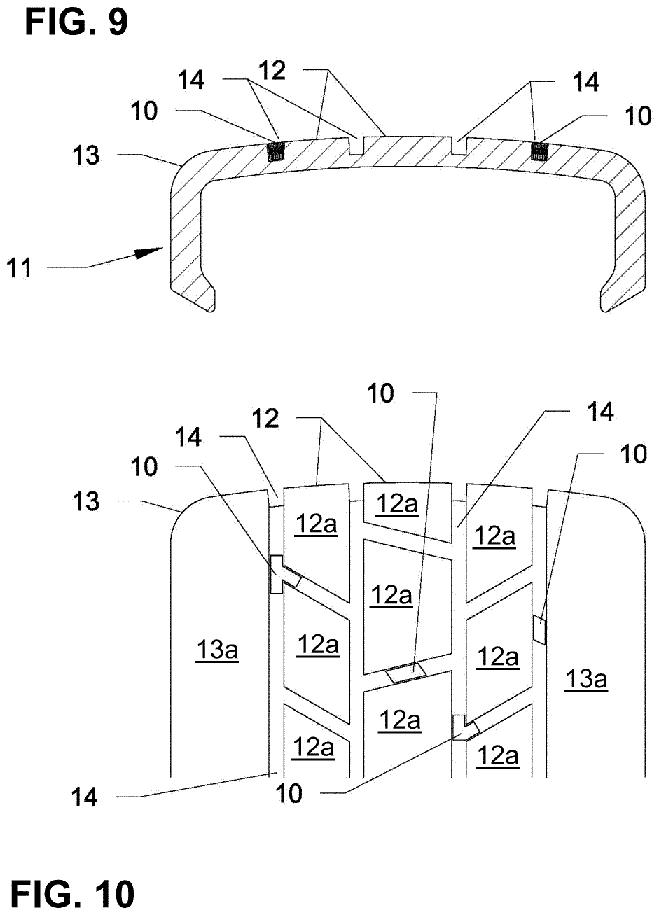

Referring now specifically to FIGS. 7-10, in some embodiments, a tire 11 includes one or more tire tread wear indicators 10 disposed within center tire tread 12, within shoulder tire tread 13 (FIGS. 7-8), and/or in tread wells 14 (FIGS. 9-10).

In embodiments wherein the tire tread wear indicator 10 is disposed within center tire tread 12 or within shoulder tire tread 13, the tire tread wear indicator 10 may be disposed within a hole 100 in the center tire tread 12 or in the shoulder tire tread 13. The hole 100 is sized and shaped to receive the tire tread wear indicator 10 securely. For example, the inner dimensions (e.g., diameter) of the hole 100 may be substantially the same or even slightly smaller than the dimensions (e.g., outer dimensions dₐ, d_{b}, etc.) of the tire tread wear indicator 10 such that a tire tread wear indicator 10 inserted into the hole 100 resists removal. In some embodiments, the hole 100 has one or more inner side walls including threads, a texture, or ridges to improve purchase of the tire tread wear indicator 10 within the hole 100. In some embodiments, the hole 100 is a stud hole configured to receive a stud such as for a winter tire.

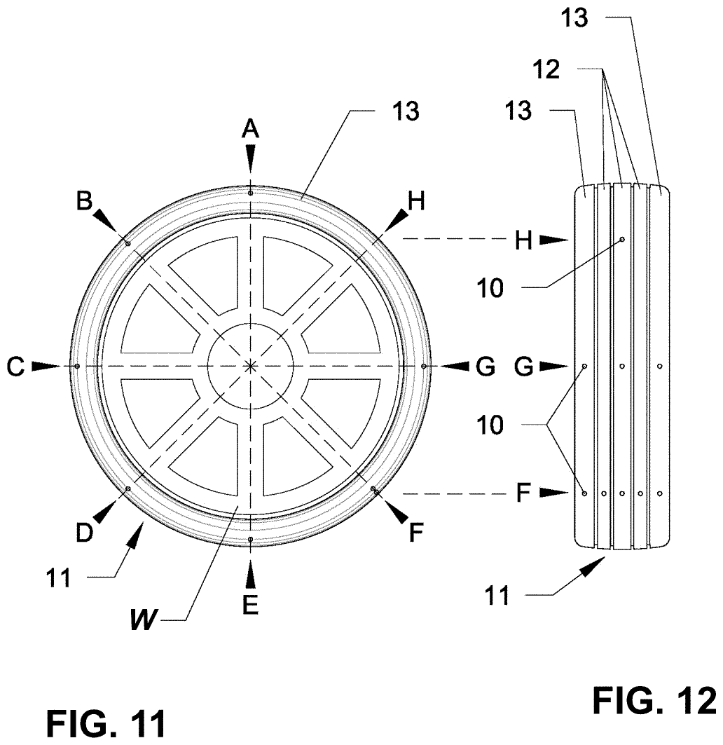

In embodiments wherein the tire tread wear indicator 10 is disposed within a tread well 14 of the tire 11, such as those generally consistent with the embodiments specifically illustrated in FIGS. 10-11, the tire tread wear indicator 10 may have a size and shape configured to fit securely within a portion of the tread well 14. For example, the tire tread wear indicator 10 may have a T-shape, a rectangular shape, a trapezoidal shape, a V-shape, a rhomboid shape, a parallelogram-shape, or any other suitable shape similar to the desired portion of the tread well 14. The tire tread wear indicator 10 may be sized slightly larger than the desired portion of the tread well 14 such that the tire tread wear indicator 10 resists removal after being inserted into the tread well 14.

In some embodiments, a plurality of tire tread wear indicators 10 are disposed about the circumference of the tire 11, such as at or near one or more of points A-H shown in FIGS. 11-12. In some embodiments, the tire tread wear indicators 10 are disposed in a pattern about the circumference of the tire 11. For example and without limitation, the embodiment specifically illustrated in FIGS. 11-12 includes five tire tread wear indicators 10 disposed at area F of the tire 11: one disposed in the inside shoulder tread 13, three disposed in the center tire tread 12, and one disposed in the outside shoulder tread 13. The same embodiment also includes three tire tread wear indicators 10 disposed at area G of the tire 11: one disposed in the inside shoulder tread 13, one disposed in the center tire tread 12, and one disposed in the outside shoulder tread 13. The same embodiment also includes one tire tread wear indicator 10 disposed at area G of the tire 11: one disposed in the center shoulder tread 13. Other embodiments include the same number of tire tread wear indicators 10 disposed at each of areas A-G of the tire 11. Still other embodiments include the same number of tire tread wear indicators 10 disposed at regular intervals around the circumference. For example and without limitation, the same number of tire tread wear indicators 10 may be disposed in shoulder tread 13 and center tread 12 at areas A, C, E, and G, while a different number of tire tread wear indicators 10 may be disposed in shoulder tread 13 and center tread 12 at areas B, D, F, and H.

In some embodiments, the tire tread wear indicator 10 is disposed in the tire 11 such that the outermost end 10a is flush or substantially flush with the surface 12a of the center tread 12, with the surface 13a of the shoulder tread 13. In embodiments wherein the tire tread wear indicator 10 is disposed in tread well 14 of the tire 11, the tire tread wear indicator 10 may be disposed in the tread well 14 such that the outermost end 10a is flush or substantially flush with the surfaces 12a, 13a of the center tread 12 and/or shoulder tread 13 immediately adjacent to the tire tread well indicator 10.

3. Methods of Making Tires Including Tire Tread Wear Indicators

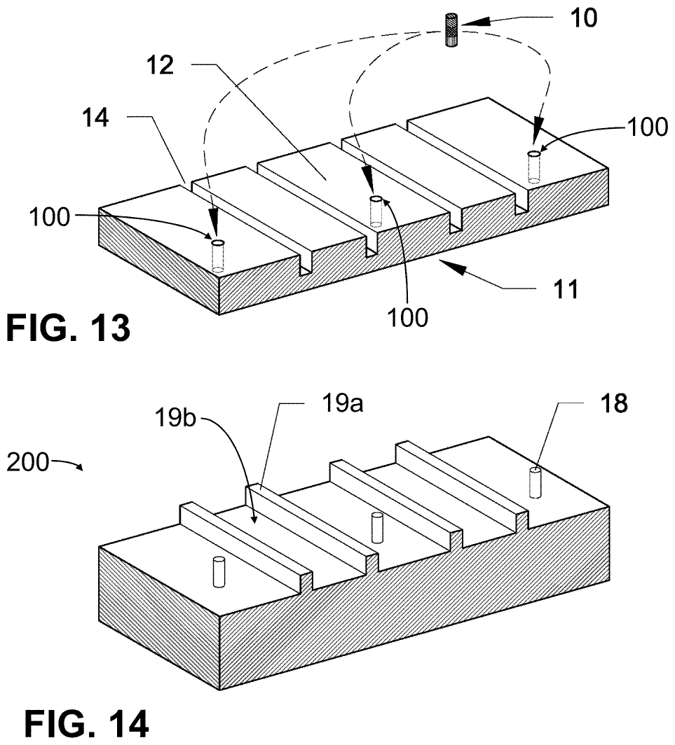

Referring now generally to FIGS. 13-14, the present disclosure provides methods of making tires 11 including tire tread wear indicators 10.

In one embodiment, the method comprises providing a mold 200 including a plurality of protrusions 19a corresponding to tire tread wells 14 and defining mold wells 19b that correspond to blocks and ribs of a molded tire 11. The mold 200 further includes a plurality of second protrusions 18 corresponding to holes 100 configured to receive tire tread wear indicators 10. The second protrusions 18 may be sized and shaped consistent with the tire tread wear indicators 10 to be inserted into the molded holes 100.

In another embodiment, a method of making tires including tire tread wear indicators 10 comprises forming one or more holes 100 in a molded tire, and thereafter inserting a tire tread wear indicator 10 into each hole 100. The step of forming the one or more holes 100 may include forming each hole to have a size and shape consistent with the tire tread wear indicators 10.

In some embodiments, the second protrusions 18 may include second protrusions 18 in mold wells 19b corresponding to the shoulder tread 13 that are of a different size and/or shape than second protrusions 18 in mold wells 19b corresponding to the center tread 12. In these embodiments, the tire tread wear indicators 10 inserted into the holes 100 in the center tread 12 may be of a different configuration (e.g., may have different thicknesses t₁₅₋₁₈ for their indicator layers 15-18 and/or a different number of layers 15-18) than the configuration (e.g., thicknesses t₁₅₋₁₈ for their indicator layers 15-18 and/or number of indicator layers 15-18) of tire tread wear indicators 10 inserted into the holes 100 in the shoulder tread 13.

4. Methods of Diagnosing Vehicle Issues

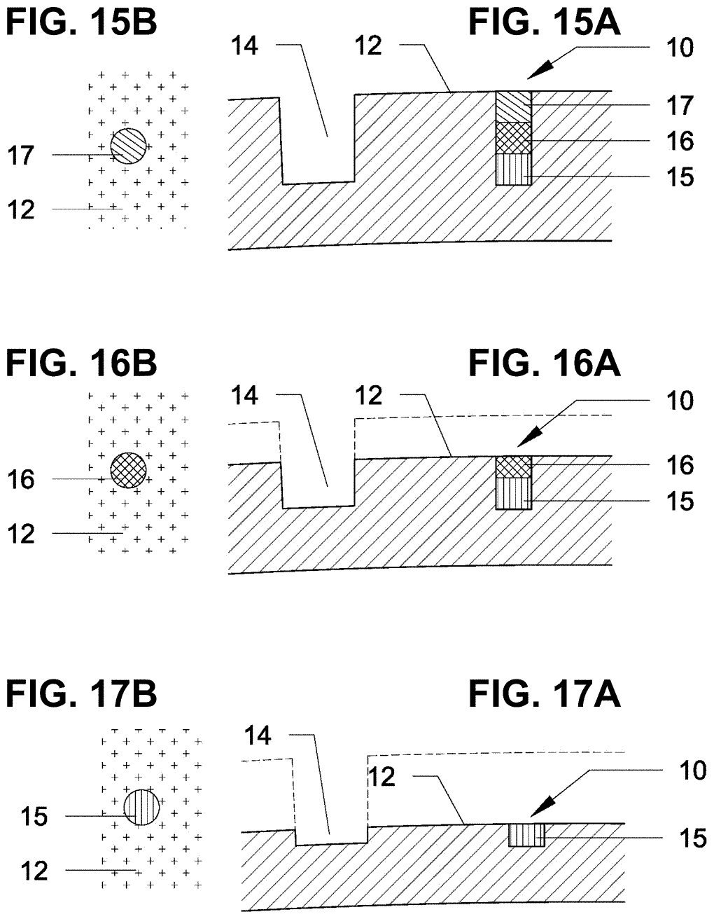

Referring now generally to FIGS. 15A-21, the present disclosure provides methods of diagnosing vehicle issues using tire tread wear indicators 10.

Generally, methods of diagnosing vehicle issues comprise installing tires 11 including a plurality of tire tread wear indicators 10 onto a vehicle, driving the vehicle for a threshold distance or time, observing local levels of tread wear associated with each tire tread wear indicator 10, and determining a vehicle issue based at least on the observed local levels of tread wear. The steps of observing local levels of tread wear and/or determining a vehicle issue may be performed (e.g., automatically performed) by a computer configured to collect observable data (e.g., a location on the perimeter of the tire 11 and an indicator color and/or a visible pattern) associated with each tire tread wear indicator 10 and/or to analyze collected observable data associated with each tire tread wear indicator 10 to determine a vehicle issue based on the observable data.

As the tire 11 is used over time, tread 12 wears down radially as shown in FIGS. 15A-17B. Initially (FIGS. 15A-15B), the tire 11 includes full tread 12, and the outermost indicator layer 17 of the installed tire tread wear indicator 10 is exposed. After a first period of use (FIGS. 16A-16B), the tread 12 has worn proximal to the tire tread wear indicator 10, and now the second indicator layer 16 is visible. After an additional period of use (FIGS. 17A-17B), more tread 12 has worn proximal to the tire tread wear indicator 10, and now the first indicator layer 15 is visible.

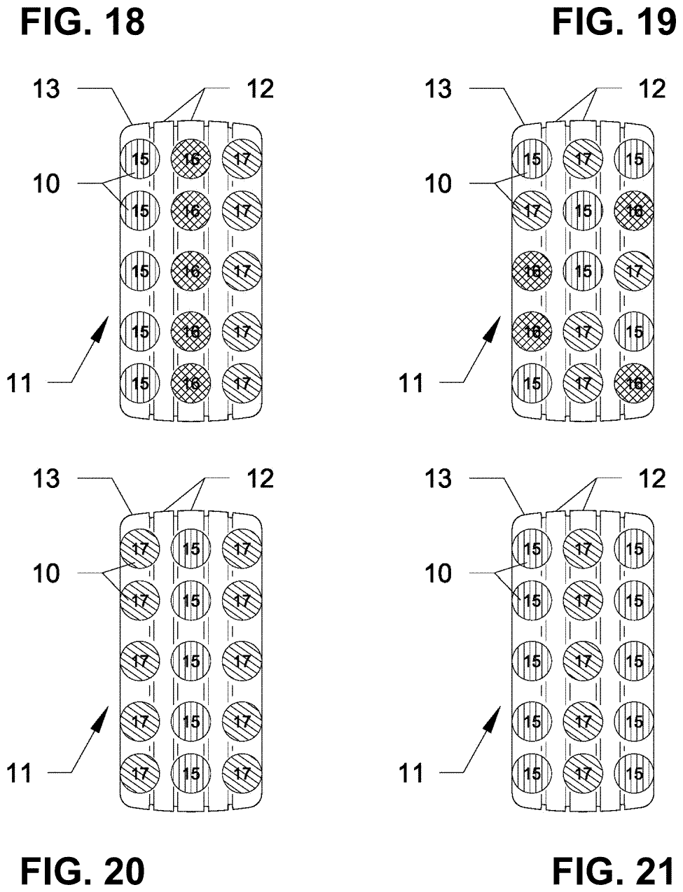

Tires do not always wear evenly, however. As shown in FIGS. 18-21, patterns of uneven wear may emerge as tires 11 including a plurality of tire tread wear indicators 10 are used. For example, uneven tread wear in a pattern similar to that shown in FIG. 18 may indicate a steering alignment issue. A method of diagnosing a steering alignment issue consistent with the present disclosure may therefore include observing the first indicator layer 15 in a plurality of tire tread wear indicators 10 disposed in a first shoulder tread 13 of the tire 11 and observing the third (outermost) indicator layer 17 or the second indicator layer 16 in a plurality of tire tread wear indicators 10 disposed in a second, opposite shoulder tread 13 of the tire 11, and thereafter determining a steering alignment issue based at least on the observed pattern of indicator layers.

In another non-limiting example, uneven tread wear pattern in a pattern similar to that shown in FIG. 19 may indicate a tire balance issue. A method of diagnosing a tire out-of-balance condition consistent with the present disclosure may therefore include observing the first indicator layer 15 in a plurality of tire tread wear indicators 10 disposed in a first shoulder tread 13 of the tire 11 and in a second shoulder tread 13 of the tire 11 and in center tread 12 of the tire 11, observing the third (outermost) indicator layer 17 in a plurality of tire tread wear indicators 10 disposed in a first shoulder tread 13 of the tire 11 and in a second shoulder tread 13 of the tire 11 and in center tread 12 of the tire 11, and observing the second indicator layer 16 (if present) in a plurality of tire tread wear indicators 10 disposed in a first shoulder tread 13 of the tire 11 and in a second shoulder tread 13 of the tire 11 and in center tread 12 of the tire 11; and thereafter determining a steering alignment issue based at least on the observed pattern of indicator layers.

In yet another non-limiting example, uneven tread wear in a pattern similar to that shown in FIG. 20 may indicate that the tire 11 is overinflated. A method of diagnosing a tire overinflation condition consistent with the present disclosure may therefore include observing the third indicator layer 17 in a plurality of tire tread wear indicators 10 disposed in a first shoulder tread 13 of the tire 11 and in a second, opposite shoulder tread 13 of the tire 11, observing the first indicator layer 15 in a plurality of tire tread wear indicators 10 disposed in center tread 12 of the tire 11, and thereafter determining a tire overinflation condition based at least on the observed pattern of indicator layers.

In yet another non-limiting example, uneven tread wear in a pattern similar to that shown in FIG. 21 may indicate that the tire 11 is underinflated. A method of diagnosing a tire underinflation condition consistent with the present disclosure may therefore include observing the first indicator layer 15 in a plurality of tire tread wear indicators 10 disposed in a first shoulder tread 13 of the tire 11 and in a second, opposite shoulder tread 13 of the tire 11, observing the third indicator layer 17 in a plurality of tire tread wear indicators 10 disposed in center tread 12 of the tire 11, and thereafter determining a tire underinflation condition based at least on the observed pattern of indicator layers.

The step of determining the vehicle issue or condition may be performed by a computer configured to compare a captured image depicting the tire 11 or a portion thereof and the exposed indicator layers 15-18 of each visible tire tread wear indicator 10 (or similar data including positional and visual indicator information for each tire tread wear indicator 10) to a database of comparison tires associated with known vehicle issues or conditions that include a plurality of tire tread wear indicators 10 having exposed tire tread wear indicators 10. The computer may be configured to generate (e.g., display or print) a report including a suggested vehicle issue or condition based on similarity rating calculated based on the comparison of the captured image of the tire 11 to the comparison tires.

5. Methods of Conducting Business

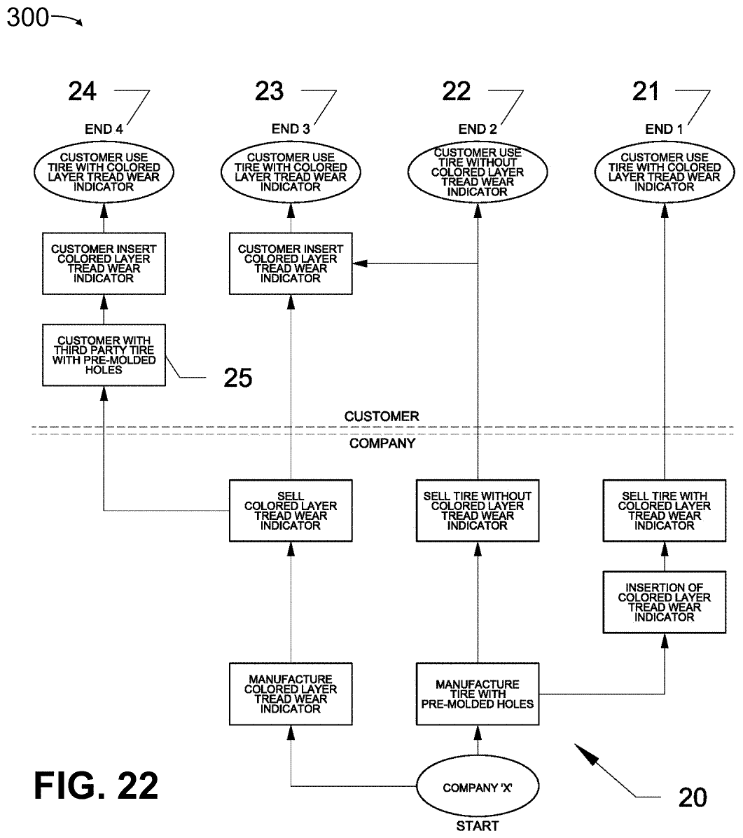

Referring now to FIG. 22, a method of conducting business 20 is described. The diagram shows four ending scenarios, from the operation of a company ‘X’ to the consumers using the product. The possibility is not limited to this but can be modified and expanded.

Company ‘X’ can manufacture the tire with pre-molded holes and they can also produce the proprietary colored layer tread wear indicator 10 or order it from other companies. Tire with pre-molded holes can have the colored layer tread wear indicator 10 inserted in the factory or customers with pre-molded hole tires can install it by themselves. Tire with pre-molded holes that are not used with the colored layer tread wear indicator 10 can be used without it. The pre-molded holes simply become a pattern of the tread of the tire 11. Company ‘X’ can control the proprietary shape of the colored layer tread wear indicator 10 and its shape of the proprietary pre-molded holes for the tire. It can license the shape of pre-molded hole 25 to other companies that will have the colored layer tread wear indicator 10 inserted.

Ending 1 (21) is a customer using a tire with pre-installed colored layer tread wear indicator 10. Ending 2 (22) is a customer using the tire without the colored layer tread wear indicator 10, and the pre-molded holes in the tire is simply a pattern and function of a tread of the tire 11. Ending 3 (23) is a customer using a tire that has self installed colored layer tread wear indicator 10. Ending 4 (24) is a customer using a third party tire that license the shape of pre-molded hole 25 from company ‘X’ that has self installed colored layer tread wear indicator 10.

1. A tire tread wear indicator comprising:
a first indicator layer including a first indicator color;
a second indicator layer including a second indicator color and disposed adjacent to the first indicator layer; and
a third indicator layer including a third indicator color and disposed adjacent to the second indicator layer opposite the first indicator layer.

2. The tire tread indicator of claim 1, wherein the first indicator color is substantially different than the second indicator color, and wherein the second indicator color is substantially different than the third indicator color.

3. The tire tread wear indicator of claim 1, wherein each of the first indicator layer, the second indicator layer, and the third indicator has substantially the same thickness.

4. The tire tread wear indicator of claim 1, wherein the second indicator layer has a thickness that is greater than a thickness of the first indicator layer.

5. The tire tread wear indicator of claim 1, wherein each of the first indicator layer, the second indicator layer, and the third indicator has substantially the same durometer value.

6. The tire tread wear indicator of claim 1, further comprising a fourth indicator layer including a fourth indicator color and disposed adjacent to the third indicator layer opposite the second indicator layer,
wherein the fourth indicator color is substantially different than the third indicator color.

7. The tire tread wear indicator of claim 6, wherein the fourth indicator layer has a thickness less than the thickness of the third indicator layer.

8. The tire tread wear indicator of claim 1, wherein the third indicator layer is an outermost layer and wherein the first indicator layer is an innermost layer.

9. The tire tread wear indicator of claim 8, wherein the innermost layer includes a red color.

10. The tire tread wear indicator of claim 8, wherein the outermost layer includes a green color.

11-12. (canceled)

13. The tire tread wear indicator of claim 1, wherein the tire tread wear indicator consists essentially of a shape that is generally cylindrical, generally triangular prismatic, generally frustoconical, or generally rectangular prismatic.

14. The tire tread wear indicator of claim 13, wherein the shape is a barbed cylinder, a barbed triangular prism, a barbed frustoconical shape, or a barbed rectangular prism.

15. The tire tread wear indicator of claim 1, wherein the tire tread wear indicator is sized and shaped to fit securely within a groove of a tire tread.

16. The tire tread wear indicator of claim 1, wherein each of the layers has a durometer value harder than Shore 60 A.

17. A tire including at least one tire tread wear indicator of claim 1.

18. The tire of claim 17, wherein the tire tread wear indicator is disposed within tread of the tire such that a top surface of the first indicator layer is substantially flush with an outermost radial surface of block or ribs of the tread.

19. The tire of claim 17, wherein the tire tread wear indicator is disposed within tread of the tire such that a bottom surface of the tire tread indicator is substantially flush with an outermost radial surface of groove of the tread.

20. The tire of claim 17 comprising a first row of tire tread wear indicators disposed substantially medially around a circumference of the tire.

21. The tire of claim 17 comprising a second row of tire tread wear indicators disposed around a circumference of the tire and proximate to an inner wall of the tire.

22. The tire of claim 17 comprising a third row of tire tread wear indicators disposed around a circumference of the tire and proximate to an outer wall of the tire.

23-32 (canceled)
